(19) United States
(12) Patent Application Publication
(10) Pub. No.: US 2017/0157974 A1
(43) Pub. Date: Jun. 8, 2017

(54) ELECTROSTATIC PRINTING SYSTEMS

(71) Applicant: Hewlett-Packard Development Company, L.P., Houston, TX (US)

(72) Inventors: Alexey S. Kabalnov, San Diego, CA (US); Sarah Olakemi Akinlabi, Fort Myers, FL (US); Gil Bar-Haim, Holon (IL); Albert Teishev, Rishon le-zion (IL)

(21) Appl. No.: 15/118,366

(22) PCT Filed: Apr. 7, 2014
(86) PCT No.: PCT/US2014/033204

§ 371 Date: Aug. 11, 2016

(51) Int. Cl. B42D 25/387; B42D 25/382; G03G 15/06; G03G 9/09; G03G 9/097

(52) U.S. Cl. CPC B42D 25/387; G03G 9/0924; G03G 9/0975; G03G 9/0926; G03G 15/06; B42D 25/382

(57) ABSTRACT

The present disclosure relates to a system for electrostatic printing. The system comprises a UV colorant comprising a rare earth diketonate, a thermoplastic resin and an additive selected from at least one of an acid having a pKa of 1 to 5 and a hydroxide. The system may be used to print a security feature on a print substrate.

### BACKGROUND

Electrostatic printing typically involves creating an image on a photoconductive surface, and applying an ink comprising charged ink particles comprising colorant and resin to the photoconductive surface. The charged ink particles adhere to the photoconductive surface by an electrostatic interaction to form an image. The particles are then transferred in the form of the image to a print substrate.

The photoconductive surface is often termed a photo imaging plate (PIP). The photoconductive surface is selectively charged with a latent electrostatic image having image and background areas with different potentials. For example, an electrostatic ink composition comprising charged ink particles in a carrier liquid can be brought into contact with the selectively charged photoconductive surface. The charged ink particles adhere to the image areas of the latent image while the background areas remain clean. The image is then transferred to a print substrate (e.g. paper) directly or, more commonly, by being first transferred to an intermediate transfer member, which can be a soft swelling blanket, and then to the print substrate.

Security inks may be used to print images that are invisible under, for example, white light but visible when irradiated with light of a specific wavelength, for example, UV light. Such inks typically contain colorants that absorb light in the UV range and emit light (luminesce) in the visible or infra-red of the electromagnetic spectrum. UV colorants are often used to print barcodes and other security features in, for example, identity documents, such as passports and identity cards. Some security inks are electrostatic ink compositions that are printed by electrostatic printing.

### DESCRIPTION

Before particular examples of the present disclosure are disclosed and described, it is to be understood that the present disclosure is not limited to the particular systems, methods, print substrates, ink compositions and ink sets disclosed herein. It is also to be understood that the terminology used herein is used for describing particular examples only and is not intended to be limiting, as the scope of protection will be defined by the claims and equivalents thereof.

In describing and claiming the devices, systems and methods, the following terminology will be used: the singular forms “a”, “an”, and “the” include the plural unless the context clearly dictates otherwise. Thus, for example, reference to “a pigment” includes reference to one or more pigments.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 weight % to about 20 weight % should be interpreted to include not only the explicitly recited concentration limits of about 1 weight % to about 20 weight %, but also to include individual concentrations such as 2 weight %, 3 weight %, 4 weight %, and sub-ranges such as 5 weight % to 15 weight %, 10 weight % to 20 weight %, etc. All percentages are by weight (wt %) unless otherwise indicated.

The present disclosure relates to a system for electrostatic printing. The system comprises a UV colorant comprising a rare earth diketonate, a thermoplastic resin and an additive selected from at least one of an acid having a pKa of 1 to 5 and a hydroxide.

It has been found that, by adding an acid having a pKa of 1 to 5 or a hydroxide to the electrostatic printing system, the luminescence intensity and/or thermal stability of the UV colorant can be improved.

The system may be used to print a security feature on a print substrate.

In one example, the system is an electrostatic ink composition comprising the colorant, thermoplastic resin and additive.

In another example, the system is an electrostatic ink set comprising an electrostatic ink composition comprising the colorant and thermoplastic resin, and a pre-treatment or post-treatment composition comprising the additive. In other words, the acid or hydroxide may be applied to the print substrate before or after application of the electrostatic ink composition comprising the colorant and thermoplastic resin.

The present disclosure also relates to a method of electrostatic printing. The method comprises one of procedures (A) to (C) below:

In procedure (A), a latent electrostatic image is formed on a surface. An electrostatic ink composition comprising a UV colorant comprising a rare earth diketonate, a thermoplastic resin and an additive selected from at least one of an acid having a pKa of 1 to 5 and a hydroxide is applied onto the latent electrostatic image to form an image on the surface. The image formed on the surface is transferred to a print substrate.

In procedure (B), a latent electrostatic image is formed on a surface. An electrostatic ink composition comprising a UV colorant comprising a rare earth diketonate and a thermoplastic resin is applied onto the latent electrostatic image to form an image on the surface. A print substrate is pre-treated with a pre-treatment composition comprising an additive selected from at least one of a polyacid and a hydroxide. The image formed on the surface is transferred to the pre-treated print substrate.

In procedure (C), a latent electrostatic image is formed on a surface. An electrostatic ink composition comprising a UV colorant comprising a rare earth diketonate and a thermoplastic resin is applied onto the latent electrostatic image to form an image on the surface. The image formed on the surface is transferred to a print substrate. The printed print substrate is treated with a post-treatment composition comprising an additive selected from at least one of an acid having a pKa of 1 to 5 and a hydroxide.

The present disclosure also relates to a printed substrate comprising a printed image that is invisible under white light but visible when irradiated with UV light. The printed substrate is obtainable by the method described herein.

The present disclosure further relates to a method of producing an electrostatic ink composition. The method comprises adding an additive selected from at least one of an acid having a pKa of 1 to 5 and a hydroxide to composition comprising a UV colorant comprising a rare earth diketonate and a thermoplastic resin.

### Colorant

As described above, the colorant comprises a rare earth diketonate. Accordingly, the colorant comprises a rare earth complex comprising at least one diketonate (e.g. 1, 2, 3, 4, 5, or 6 diketonates). The diketonate may be an aliphatic or an aromatic diketonate. The diketonate may be a β-diketonate, for example, an aliphatic or aromatic β-diketonate. In one example, the at least one diketonate ligand is an aromatic β-diketonate.

Suitable diketonates may have the formula (I):

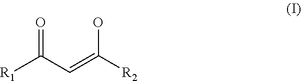

wherein R₁ and R₂ are each independently selected from alkyl, halo alkyl, aryl or heteroaryl group.

Where R₁ and/or R₂ is an alkyl group, the alkyl group may be a C₁ to C₆ alkyl, for example, a C₁ to C₄ alkyl. Examples of suitable alkyl groups include methyl, ethyl, propyl and butyl (e.g. i-butyl, t-butyl or n-butyl).

Where R₁ and/or R₂ is a haloalkyl group, the haloalkyl group may include a halogen atom selected from F, Cl, Br and I. In one example, the halo group is a fluoro group. Suitable haloalkyl groups may include 1 to 15 carbon atoms, for example, 1 to 10 carbon atoms. The haloalkyl groups may be linear or branched.

Where R₁ and/or R₂ is an aryl group, the aryl group may be a C₆ to C₂₀ aryl group. Suitable aryl groups include phenyl or naphthyl groups. The aryl groups may optionally be substituted. Suitable substituents include alkyl (e.g. C₁ to C₆ alkyl), halo (e.g. F, Cl, Br, I), ether (e.g. —OR′, where R′ is an alkyl, for example, a C₁ to C₆ alkyl) and thioether (e.g. —SR′, where R′ is an alkyl, for example, a C₁ to C₆ alkyl) groups.

Where R₁ and/or R₂ is a heteroaryl group, the heteroaryl group may have at least one heteroatom selected from oxygen, nitrogen and sulphur. Suitable heteroaryl groups include furanyl, thiophene-yl and pyridyl groups. In one example, the heteroaryl group is a thiophene-yl group.

In one example, the diketonate is an aromatic 1,3-diketonate. Accordingly, the diketonate may be of the formula I above, wherein at least one of R₁ and/or R₂ is an aromatic group selected from at least one of heteroaryl and aryl. In one example, R₁ is a thiophene-yl group, while R₂ is a haloalkyl group, for instance, a fluoroalkyl group. In yet another example, R₁ is a thiophene-yl group, while R₂ is a fluoromethyl group (as shown in Formula II below):

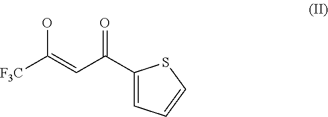 [SMILES: O=C(/C=C(\O)C(F)(F)F)c1cccs1]

Other examples of suitable diketonates (listed below in their protonated form) include:
acetylacetone
perfluoroacetylacetone
heptafluoroacetylacetone
benzoyl-2-furanoylmethane
1,3-bis(3-pyridyl)-1,3-propanedione
benzoyltrifluoroacetone
benzoylacetone
di(4-bromo)benzoylmethane
d,d-dicampholylmethane
4,4_-dimethoxydibenzoylmethane
2,6-dimethyl-3,5-heptanedione
dinaphthoylmethane
dipivaloylmethane
di(perfluoro-2-propoxypropionyl)methane
1,3-di(2-thienyl)-1,3-propanedione
3-(trifluoroacetyl)-d-camphor
6,6,6-trifluoro-2,2-dimethyl-3,5-hexanedione
1,1,1,2,2,6,6,7,7,7-decafluoro-3,5-heptanedione
6,6,7,7,8,8,8-heptafluoro-2,2-dimethyl-3,5-octanedione
2-furyltrifluoroacetone
hexafluoroacetylacetone
3-(heptafluorobutyryl)-d-camphor
4,4,5,5,6,6,6-heptafluoro-1-(2-thienyl)-1,3-hexanedione
4-methylbenzoyl-2-furanoylmethane
6-methyl-2,4-heptanedione
2-naphthoyltrifluoroacetone
3-(5-phenyl-1,3,4-oxadiazol-2-yl)-2,4-pentanedione
3-phenyl-2,4-pentanedione
pivaloyltrifluoroacetone
1-phenyl-3-(2-thienyl)-1,3-propanedione
3-(tert-butylhydroxymethylene)-d-camphor
trifluoroacetylacetone
1,1,1,2,2,3,3,7,7,8,8,9,9,9-tetradecafluoro-4,6-nonanedione
2,2,6,6-tetramethyl-3,5-heptanedione
4,4,4,-trifluoro-1-(2-naphtyl)-1,3-butanedione
2,2,6,6-tetramethyl-3,5-octanedione
2,2,6-trimethyl-3,5-heptanedione
2,2,7-trimethyl-3,5-octanedione
2-thenoyltrifluoroacetone

The rare earth diketonates may include one or more additional ligands/anions in addition to the at least one diketonate. These additional ligands/anions may act as Lewis bases. Suitable additional ligands/anions include 2, 2′-bipyridine, 1, 10-phenanthroline, 2,2′,6′2″-terpyridyl, bathohenanthroline or 4,7-diphenyl-1,10-phenanthroline; 1-(2-pyridyl)benzimidazole; triphenylphosphine oxide; tri-n-butylphosphine oxide, tri-n-octylphosphine oxide, tributylphosphate and dimethylsulfoxide.

In one example, the rare earth diketonate has at least one, for instance, 2 to 9 (e.g. 2, 3, 4, 5 or 6) additional ligands/anions. In another example, the rare earth diketonate has 2, 3 or 4 additional ligands/anions. The additional ligand/anion may be a phosphine oxide ligand, for example, triphenylphosphine oxide.

The rare earth diketonate may include any rare earth metal. Suitable metals include the lanthanide metals, scandium and yttrium. In one example, the rare earth metal is a lanthanide metal. Suitable lanthanide metals include Lanthanum (La), Cerium (Ce), Praseodymium (Pr), Neodymium (Nd), Promethium (Pm), Samarium (Sm), Europium (Eu), Gadolinium (Gd), Terbium (65), Dysprosium (Dy), Holmium (Ho), Erbium (Er), Thulium (Tm), Ytterbium (Yb) and Lutetium (Lu). In one example, the lanthanide is Sm, Eu, Tb and Dy. In another example, the lanthanide metal is Eu. The lanthanide metal may be a lanthanide metal in the +3 oxidation state (M(III)). In one example, the rare earth diketonate is a Eu(III) diketonate complex. For instance, the rare earth diketonate may be:

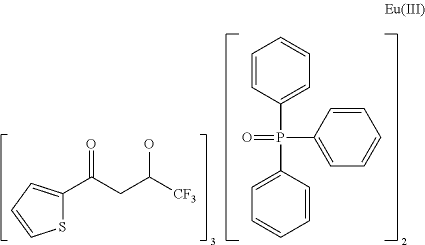

Tris(1-(2-thienyl)-4,4,4,trifluoro-1,3-butanedion ato)bis(triphenylphosphine oxide) Eu(III)

The UV colorant may be one that absorbs electromagnetic radiation in the UV part of the electromagnetic spectrum and emits electromagnetic radiation in the IR or visible part of the electromagnetic spectrum. The absorbed light may have a wavelength in the range of 10 to below 400 nm, for example, 250 to 380 nm. In one example, the absorbed light has a wavelength of 340 to 360 nm, for instance, 350 nm. The emitted light may have a wavelength of 400 to 1400 nm, for example, 400 to 700 nm. In one example, the UV colorant absorbs light in the UV and emits light (luminesces) in the visible part of the electromagnetic spectrum. The emitted light may be red. In one example, the emitted light may have a wavelength of about 600 to 620 nm, for example, 615 nm.

### Thermoplastic Resin

As discussed above, the systems described herein include a thermoplastic resin. The resin may be acidic and/or may be ionomeric. The resin may be or comprise a homopolymers and/or copolymer. In one example, the resin is a copolymer. The resin may be a copolymer of an alkylene and a co-monomer selected from acrylic acid, methacrylic acid, an ester of acrylic acid and an ester of methacrylic acid. At least 50%, for example, at least 70% (e.g. 75 to 95%) of the copolymer may be derived from the alkylene. In another example, the resin may be a copolymer of an alkylene and maleic anhydride. At least 50%, for example, at least 80% (e.g. 85 to 99%) of the copolymer may be derived from the alkylene.

The resin may be selected from ethylene acrylic acid copolymers; ethylene methacrylic acid copolymers; ethylene vinyl acetate copolymers; copolymers of ethylene (e.g. 80 wt % to 99.9 wt %) and alkyl (e.g. C1 to C5) ester of methacrylic or acrylic acid (e.g. 0.1 wt % to 20 wt %); copolymers of ethylene (e.g. 80 wt % to 99.9 wt %), acrylic or methacrylic acid (e.g. 0.1 wt % to 20.0 wt %) and alkyl (e.g. C1 to C5) ester of methacrylic or acrylic acid (e.g. 0.1 wt % to 20 wt %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is optionally from 1 to about 20 carbon atoms, such as methyl (e.g. 50 wt % to 90 wt %)/methacrylic acid (e.g. 0 wt % to 20 wt %)/ethylhexylacrylate (e.g. 10 wt % to 50 wt %); ethylene-acrylate 30 terpolymers: ethylene-acrylic esters-maleic anhydride (MAH) or glycidyl methacrylate (GMA) terpolymers; ethylene-acrylic acid ionomers and combinations thereof.

The resin may be a polymer having acidic side groups. The polymer having acidic side groups may have an acidity of 50 mg KOH/g or more, for example an acidity of 60 mg KOH/g or more. In one example, the resin may have an acidity of 70 mg KOH/g or more, or an acidity of 80 mg KOH/g or more (e.g. an acidity of 90 mg KOH/g or more). In a further example, the resin may have an acidity of 100 mg KOH/g or more, for example, 105 mg KOH/g or more. In another example, the acidity of the resin may be 110 mg KOH/g or more, for example, 115 mg KOH/g or more. The resin may have an acidity of 200 mg KOH/g or less, for example 190 mg or less. In one example, the acidity is 180 mg or less, optionally 130 mg KOH/g or less, for example, 120 mg KOH/g or less.

For the avoidance of doubt, “acidity” as used herein refers to the mass of potassium hydroxide (KOH) in milligrams that is required to neutralise one gram of a substance. The acidity of the resin refers to the acidity of the resin alone, in the absence of any of the other components of the inkjet ink composition or system. Acidity of a resin, as measured in mg KOH/g can be measured using standard procedures known in the art, for example using the procedure described in ASTM D1386.

The resin may comprise a polymer that has a melt flow rate of less than about 60 g/10 minutes, for example, 50 g/10 minutes or less. In one example, the polymer has a melt flow rate of about 40 g/10 minutes or less, for example, 30 g/10 minutes or less. In another example, the polymer has a melt flow rate of 20 g/10 minutes or less, for instance, 10 g/10 minutes or less. In one example, all polymers in the thermoplastic resin each individually have a melt flow rate of less than 90 g/10 minutes, 80 g/10 minutes or less, for instance, 80 g/10 minutes or less. In another example, all polymers in the thermoplastic resin each individually have a melt flow rate of less 70 g/10 minutes or less, optionally 70 g/10 minutes or less, for example, 60 g/10 minutes or less.

The thermoplastic resin may comprise a polymer having a melt flow rate of about 10 g/10 minutes to about 120 g/10 minutes, for example, about 10 g/10 minutes to about 70 g/10 minutes. In one example, the polymer may have a melt flow rate of about 10 g/10 minutes to 40 g/10 minutes, for instance, 20 g/10 minutes to 30 g/10 minutes. The polymer can have a melt flow rate of optionally about 50 g/10 minutes to about 120 g/10 minutes, for example, 60 g/10 minutes to about 100 g/10 minutes. The melt flow rate can be measured using standard procedures known in the art, for example, as described in ASTM D1238-04-c.

All polymers in the thermoplastic resin may have a melt flow rate of about 10 g/10 minutes to about 120 g/10 minutes, for example, about 10 g/10 minutes to about 70 g/10 minutes. In one example, all polymers in the resin may have a melt flow rate of about 10 g/10 minutes to 40 g/10 minutes, for instance, 20 g/10 minutes to 30 g/10 minutes. All polymers in the resin can have a melt flow rate of optionally about 50 g/10 minutes to about 120 g/10 minutes, for example, 60 g/10 minutes to about 100 g/10 minutes. The melt flow rate can be measured using standard procedures known in the art, for example, as described in ASTM D1238-04-c.

For the avoidance of doubt, the “melt flow rate” generally refers to the extrusion rate of a resin through an orifice of defined dimensions at a specified temperature and load, usually reported as temperature/load e.g. 190° C./2.16 kg. In the present disclosure, “melt flow rate” is measured according to ASTM D-1238-04c Standard Test Method for Melt Flow Rates of Thermoplastics by Extrusion Plastomer.

The thermoplastic resin may comprise a polymer having acidic side groups. In one example, all polymers in the resin have acidic side groups. Examples of suitable polymers include copolymers of ethylene and an ethylenically unsaturated acid of either acrylic acid or methacrylic acid, and ionomers thereof. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt % to 25 wt % of the copolymer, for instance, from 15 wt % to 20 wt % of the copolymer.

The thermoplastic resin may be or comprise two or more different polymers having acidic side groups. The two polymers having acidic side groups may have different acidities, which may fall within the ranges mentioned above. The resin may comprise a first polymer having acidic side groups that has an acidity of from 50 mg KOH/g to 110 mg KOH/g and a second polymer having acidic side groups that has an acidity of 110 mg KOH/g to 130 mg KOH/g. In one example, the resin may comprise a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to 30 about 120 g/10 minutes and an acidity of 110 mg KOH/g to 130 mg KOH/g.

The thermoplastic resin may comprise a polymer having a melt viscosity of 15,000 poise or less, for example, a melt viscosity of 10,000 poise or less. The thermoplastic resin may have a melt viscosity of 15,000 poise or less. In one example, the thermoplastic resin may be or may comprise a polymer having a melt viscosity of 1000 poise or less, for example, 100 poise or less. In another example, the thermoplastic resin may be or may comprise a polymer having a melt viscosity of 50 poise or less, for instance, 10 poise or less.

In one example, the thermoplastic resin may comprise two or more polymers having different melt viscosities. If the resin includes a single type of polymer, the polymer may have a melt viscosity of 6000 poise or more, for example a melt viscosity of 8000 poise or more; 10000 poise or more or 12000 poise or more. If the resin includes a plurality of polymers, all the polymers may together form a mixture that has a melt viscosity of 6000 poise or more, for example, a melt viscosity of 8000 poise or more. In one example, the mixture may have a melt viscosity of 10000 poise or more, for instance, a melt viscosity of 12000 poise or more.

Fort the avoidance of doubt, the “melt viscosity” refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or a constant rate depending on equipment. Measurements are taken once the system has reached steady-state operation. One method used is measuring Brookfield viscosity @ 140° C. (units mPa-s or cPoise). Alternatively, the melt viscosity can be measured using a rheometer, e.g. a commercially available AR-2000 rheometer from thermal analysis instruments, using the geometry of 25 mm steel plate-standard steel parallel plate, and finding the plate over plate rheometry isotherm at 120° C., 0.01 Hz shear rate.

The thermoplastic resin may comprise a resin comprising two different polymers having acidic side groups that are selected from copolymers of ethylene and an ethylenically unsaturated acid of either methacrylic acid or acrylic acid; and ionomers thereof. The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt % to about 16 wt % of the copolymer, optionally 10 wt % to 16 wt % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt % to about 30 wt % of the copolymer, for example, from 14 wt % to about 20 wt %; 16 wt % to about 20 wt % or 17 wt % to 19 wt % of the copolymer.

In an example, the resin constitutes about 5 to 90%, for instance, about 5 to 80%, by weight of the solids of the electrostatic ink composition. In another example, the resin constitutes about 10 to 60% by weight of the solids of the electrostatic ink composition. In yet another example, the resin constitutes about 15 to 40% by weight of the solids of the electrostatic ink composition comprising the resin, colorant and, optionally, the additive. In another example, the resin constitutes about 60 to 90% by weight, for instance, from 70 to 80% by weight, of the solids of the electrostatic ink composition.

The thermoplastic resin may comprise a polymer having acidic side groups, as described above (which is may be free of ester side groups), and a polymer having ester side groups. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, optionally 1 to 20 carbons, 10 optionally 1 to 10 carbons; optionally selected from methyl, ethyl, isopropyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, optionally an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the co-polymer, for example, 5 to 40% by weight; 5 to 20% by weight of the copolymer or 5 to 15% by weight of the copolymer. The second monomer may constitute 1 to 50% by weight of the co-polymer, for example, 5 to 40% by weight of the co-polymer; 5 to 20% by weight of the co-polymer or 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In another example, the first monomer constitutes 5 to 15% by weight of the co-polymer, the second monomer constitutes 5 to 15% by weight of the co-polymer, with the third monomer constituting the remaining weight of the copolymer. In a further example, the first monomer constitutes 8 to 12% by weight of the co-polymer, the second monomer constitutes 8 to 12% by weight of the co-polymer, with the third monomer constituting the remaining weight of the copolymer. In yet another example, the first monomer constitutes about 10% by weight of the co-polymer, the second monomer constitutes about 10% by weight of the co-polymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total weight of the thermoplastic resin. The polymer having ester side groups may constitute 5% or more by weight of the total weight of the thermoplastic resin, for example, 8% or more, 10% or more, 15% or more, of the total weight of the thermoplastic resin. The polymer having ester side groups may constitute from 5% to 50% by weight of the total amount of the resin, for example 10% to 40% by weight or 15 to 30 weight % of the total weight of the thermoplastic resin.

The polymer having ester side groups may have an acidity of 50 mg KOH/g or 30 more, for example, an acidity of 60 mg KOH/g or more, 70 mg KOH/g or more, or 80 mg KOH/g or more. The polymer having ester side groups may have an acidity of 100 mg KOH/g or less, for example, 90 mg KOH/g or less. The polymer having ester side groups may have an acidity of 60 mg KOH/g to 90 mg KOH/g, for instance, 70 mg KOH/g to 80 mg KOH/g.

The polymer having ester side groups may have a melt flow rate of about 10 5 g/10 minutes to about 120 g/10 minutes, optionally about 10 g/10 minutes to about 50 g/10 minutes, optionally about 20 g/10 minutes to about 40 g/10 minutes, optionally about 25 g/10 minutes to about 35 g/10 minutes.

In an example, the thermoplastic resin may be or include a polymer or polymers selected from at least one of the Nucrel family of toners (e.g. Nucrel 403™, Nucrel 407™ Nucrel 609HS™, Nucrel 908HS™, Nucrel 1202HC™, Nucrel 30707™ Nucrel 1214™, Nucrel 903™, Nucrel 3990™ Nucrel 910™, Nucrel 925™, Nucrel 699™, Nucrel 599™ Nucrel 960™, Nucrel RX 76™, Nucrel 2806™, Bynell 2002, Bynell 2014, and Bynell 2020 (sold by E. I. du PONT)), the Aclyn family of toners (e.g. Aaclyn 201, Aclyn 246, Aclyn 285, and Aclyn 295), and the Lotader family of toners (e.g. Lotader 2210, Lotader, 3430, and Lotader 8200 (sold by Arkema)).

The thermoplastic resin can encapsulate the colorant (e.g. during grinding or mixing) to create an ink particle. The ink particle can have a final particle size from about 1 micron to 20 about 10 microns and produce a printed image at thickness of about 1 micron per separation. The resin encapsulated colorant can be formulated to provide a specific melting point. In one example, the melting point can be from about 30° C. to about 150° C. In another example, the melting point can be from about 50° C. to about 100° C. Such melting points can allow for desired film formation 25 during printing. The electrostatic ink composition may contain particles which comprise the resin, which may be homogenously distributed throughout each particle.

The thermoplastic resin may have or may comprise polymer(s) having a weight average molecular weight (Mw) in excess of 20,000, for example, in excess of 50,000. In one example, the thermoplastic resin may have or may comprise polymer(s) having a molecular weight of at least 80,000, for example, 100,000 to 800,000.

### Additive

As discussed above, the system described herein comprises an additive that is an acid having a pKa of 1 to 5 or a hydroxide. The additive is provided in addition to the colorant and thermoplastic resin in the system. In one example, the additive is either an acid having a pKa of 1 to 5 or a hydroxide.

Where the additive is an acid having a pKa of 1 to 5, the acid may have a pKa of 1.5 to 4.5, for example, 2 to 4. In one example, the acid may have a pKa of 2 to 3.5.

The acid may be an inorganic or organic (i.e. carboxylic) acid. The acid may be a polyacid. Accordingly, the polyacid has 2 or more acid groups. In one example, the acid is a polycarboxylic acid. Suitable polycarboxylic acids include polycarboxylic acids having 2 to 6 carbon atoms between carboxylic acid groups. Suitable examples include glutaric acid, adipic acid, phthalic acid and polyacrylic acid. Other suitable acids include polyphosphonic acids and salts thereof.

The acid may be polymeric or non-polymeric. Where the acid is a polymeric carboxylic acid, the polymeric carboxylic acid is a homopolymer. An example is polyacrylic acid. The polymeric carboxylic acid may have a molecular weight (Mw) of less than 10,000, for example, 1000 to 3000. In one example, the polymeric carboxylic acid may have a molecular weight of 2000. Where a polymeric carboxylic acid is employed as the additive, the polymeric carboxylic acid may have a higher number of acidic groups per polymeric molecule than any thermoplastic resin employed in the system. In one example, each repeat unit of the polymer contains at least on carboxylic group. Where the acid is a polymeric acid, the polymeric acid may be a homopolymers, for example, a homopolymeric polyacrylic acid.

Without wishing to be bound by any theory, the addition of acid is believed to stabilise the rare earth metal diketonate. Typically, rare earth metal diketonate tend to be more susceptible to decomposition under highly acidic conditions, as the metal ligands may be more labile under highly acidic conditions. Without wishing to be bound by any theory, however, the addition of an acid having a pKa of 1 to 5 is believed to stabilise the rare earth metal diketonate by interacting with the rare earth metal to provide a more stable complex. In some examples, the interaction may be improved through the use of a polyacids, as the polyacid anion may stabilise the rare earth diketonate through a chelating action.

The mole ratio of acid to UV colorant in the system may be in the range of 2-10:1, for example, 2-9:1. In one example, the mole ratio of acid to UV colorant in the system may be 3-8:1, for instance, 4-6:1.

As discussed above, the system may be an electrostatic ink composition comprising the colorant, thermoplastic resin and additive. The electrostatic ink composition may be provided as a paste concentrate that is diluted prior to use in the printing process. The paste concentrate may have a solids content of 15 to 35 weight %, for example, 18 to 25 weight %. This paste concentrate may be diluted to form a ready-to-use composition, for example, having a solids content of 0.5 to 6 weight %, for example, 1 to 5 weight % or 2 to 3 weight %. The additive may form 1 to 15 weight % of the solids of the electrostatic ink composition (whether in the form of a paste concentrate or ready-to-use form).

Where the additive is an acid, the acid may be present in an electrostatic ink composition comprising the colorant, thermoplastic resin and the additive. The electrostatic ink composition, in the form of a paste concentrate, may comprise 0.5 to 4 weight % of the acid. The acid may form 3 to 15 weight % of the solids of the electrostatic ink composition.

In another example, the acid may be formulated as a pre-treatment or post-treatment composition comprising the acid, which may be applied to the print substrate before or after application of the electrostatic ink composition comprising the colorant and thermoplastic resin.

Where the additive is a hydroxide, the hydroxide may be any alkali metal hydroxide, for example, Li, Na or K hydroxide. In one example, the hydroxide is lithium hydroxide. Without wishing to be bound by any theory, the hydroxides may be used to neutralise any acid group, for example, in the thermoplastic resin. The neutralisation is believed to provide a pH environment in which the rare earth diketonate may less susceptible to decomposition.

In one example, the hydroxide may neutralise at least some of the acid groups present in the thermoplastic resin. In another example, the hydroxide may neutralise all of the acid groups present in the thermoplastic resin.

The mole ratio of the hydroxide (e.g. LiOH) to thermoplastic resin may be 0.9-3:1, for example, 1-1.5:1.

The mole ratio of the hydroxide to the UV colorant may be 5-10:1, for example, 7:1.

In one example, the hydroxide may be present in an electrostatic ink composition comprising the colorant, thermoplastic resin and the additive. The hydroxide may form 0.1 to 10 weight %, for example, 0.3 to 3 weight % or 0.3 to 0.6 weight % of the total weight of the electrostatic ink composition in the form of a paste concentrate. The hydroxide may form 1 to 3 weight % of the solids of the electrostatic ink composition.

Where the additive is present in an electrostatic ink composition comprising the colorant, thermoplastic resin and the additive, the acid or hydroxide additive may improve the luminescence intensity of the colorant. In particular, the additive may facilitate the deposition of ink to onto the photoconductive substrate during electrostatic printing, for example, by increasing the number of charge species in the ink composition. As a result, the ink may be deposited as a thicker layer, which may result in a greater degree of luminescence.

### Carrier Liquid

The system of the present disclosure may include a carrier liquid. The carrier liquid may be a carrier for the electrostatic ink composition comprising the colorant, thermoplastic resin and optional additive.

The carrier liquid can comprise or be a hydrocarbon, silicone oil or vegetable oil. The carrier liquid can include, but is not limited to, an insulating, non-polar, non-aqueous liquid that is used as the medium for ink particles. The carrier liquid can include compounds that have a resistivity in excess of about 10⁹ ohm-cm. The carrier liquid may have a dielectric constant below about 5, for example, below about 3.

The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In particular, the carrier liquids can include, but are not limited to, 20 Isopar-G™, Isopar-H™, Isopar-L™, Isopar-M™, Isopar-K™, Isopar-V™, Norpar 12™, Norpar 13™, Norpar 15™, Exxol D40™ Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 25 Solvent H™, Nisseki Isosol 300™ Nisseki Isosol 400™ AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% 30 synthetic terpenes) (sold by ECOLINK™).

In an example, for instance, where the electrostatic ink composition is in its ready-to-use form, the carrier liquid may constitute about 20 to 99.5% by weight of the electrostatic ink composition, optionally 50 to 99.5% by weight of the electrostatic ink composition. In another example, the carrier liquid may constitute about 40 to 90% by weight of the electrostatic ink composition. In another example, the carrier liquid may constitute about 60 to 80% by weight of the electrostatic ink composition. In another example, the carrier liquid may constitute about 90 to 99.5% by weight of the electrostatic ink composition, optionally 95 to 99% by weight of the electrostatic ink composition.

In an example, for instance, where the electrostatic ink composition is in its paste concentrate form, the carrier liquid may constitute 60 to 90% by weight, for example, at least 70 to 85% by weight of the paste concentrate.

### Charge Director

The electrostatic ink composition may include a charge director. The charge director may be added to the electrostatic ink composition comprising the colorant, thermoplastic resin and optional additive to maintain sufficient electrostatic charge on ink particles comprising the thermoplastic resin and colorant. The charge director may be a surfactant, for example, an anionic, cationic or non-ionic surfactant.

In an example, the charge director may comprise ionic compounds, particularly metal salts of fatty acids, metal salts of sulfo-succinates, metal salts of oxyphosphates, metal salts of alkylbenzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. In an example, the charge director is selected from, but is not limited to, oil-soluble petroleum sulfonates (e.g. neutral Calcium Petronat™, neutral Barium Petronate™, and basic Barium™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates (e.g. see WO 2007/130069). In an example, the charge director imparts a negative charge on the particles of the ink composition.

In an example, the charge director comprises a sulfosuccinate moiety of the general formula [R¹′—O—C(O)CH₂CH(SO₃⁻)OC(O)—O—R²′], where each of R¹′ and R²′ is an alkyl group as described below. In an example, the charge director comprises nanoparticles of a simple salt and a sulfosuccinate salt of the general formula MAₙ, wherein M is a metal, n is the valence of M, and A is an ion of the general formula [R¹′—O—C(O)CH₂CH(SO₃⁻)OC(O)—O—R²′], where each of R¹′ and R²′ is an alkyl group as described below, or other charge directors as found in WO2007130069, which is incorporated herein by reference in its entirety.

As described in WO2007130069, the sulfosuccinate salt of the general formula MAₙ is an example of a micelle forming salt. The charge director may comprise micelles of such a sulfosuccinate salt enclosing at least some of the ink particles. The charge director may comprise at least some nanoparticles having a size of 200 nm or less, optionally 2 nm or more.

As described in WO2007130069, simple salts are salts that may not form micelles by themselves, although they may form a core for micelles with a micelle-forming salt. The ions constructing the simple salts are all hydrophilic. The simple salt may comprise a cation selected from the group consisting of Mg, Ca, Ba, NH4, tert-butyl ammonium, Li+, and Al+3, or from any sub-group thereof. The simple salt may comprise an anion selected from the group consisting of SO₄²⁻, PO₃⁻, NO₃⁻, HPO₄²⁻, CO₃²⁻, acetate, trifluoroacetate (TFA), Cl⁻, Br⁻, F⁻, clO₄⁻, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄. The charge director may further comprise basic barium petronate (BBP).

In the formula [R¹′—O—C(O)CH₂CH(SO₃—)OC(O)—O—R^{2′}], each of R^{1′} and R^{2′} may be an aliphatic alkyl group. Each of R^{1′} and R^{2′} may independently be a C₆₋₂₅ alkyl. The aliphatic alkyl group may be linear or branched. Optionally, said aliphatic alkyl group includes a linear chain of more than 6 carbon atoms. Optionally, R^{1′} and R^{2′} are the same. Optionally, at least one of R^{1′} and R^{2′} is —C₁₃H₂₇.

In the formula MAₙ, M may be Na, K, Cs, Ca, or Ba.

The charge director may comprise (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In an example, the charge director constitutes about 0.001% to 50%, for example, 0.01 to 20% by weight, 0.01 to 10% by weight or 0.01 to 1% by weight of the solids of the electrostatic ink composition. In another example, the charge director constitutes about 0.001 to 0.15% by weight of the solids of the electrostatic ink composition, for example 0.001 to 0.15% or 0.001 to 0.02% by weight of the solids of the electrostatic ink composition. In an example, the charge director imparts a negative charge on the particles. The particle conductivity may range from 50 to 500 pmho/cm, optionally from 200-350 pmho/cm.

The electrostatic ink composition may include a charge adjuvant. A charge adjuvant may promote charging of the particles when a charge director is present. The charge adjuvant may include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylateco-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminum di- or tristearate.

In some examples, the electrostatic ink composition further includes a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 abd Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid 15 anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant may be present in an amount of about 0.1 to 5% by weight, in some examples about 0.1 to 1% by weight, in some examples about 0.3 to 0.8% by weight of the solids of the electrostatic ink composition, in some examples about 1 wt % to 3 wt % of the solids of the electrostatic ink composition, in some examples about 1.5 wt % to 2.5 wt % of the solids of the electrostatic ink composition.

### Further Additives

The electrostatic ink composition may comprise one or more additives, for example an additive selected from a charge adjuvant, a wax, a surfactant, biocides, organic solvents, viscosity modifiers, sequestering agents, preservatives, compatibility additives, emulsifiers and the like.

### Printing Method

As discussed above, the present disclosure also relates to a method of electrostatic printing. The method comprises one of procedures (A) to (C) below:

In procedure (A), a latent electrostatic image is formed on a surface. An electrostatic ink composition comprising a UV colorant comprising a rare earth diketonate, a thermoplastic resin and an additive selected from at least one of an acid having a pKa of 1 to 5 and a hydroxide is applied onto the latent electrostatic image to form an image on the surface. The image formed on the surface is transferred to a print substrate.

In procedure (B), a latent electrostatic image is formed on a surface. An electrostatic ink composition comprising a UV colorant comprising a rare earth diketonate and a thermoplastic resin is applied onto the latent electrostatic image to form an image on the surface. A print substrate is pre-treated with a pre-treatment composition comprising an additive selected from at least one of a polyacid and a hydroxide. The image formed on the surface is transferred to the pre-treated print substrate.

In procedure (C), a latent electrostatic image is formed on a surface. An electrostatic ink composition comprising a UV colorant comprising a rare earth diketonate and a thermoplastic resin is applied onto the latent electrostatic image to form an image on the surface. The image formed on the surface is transferred to a print substrate. The printed print substrate is treated with a post-treatment composition comprising an additive selected from at least one of an acid having a pKa of 1 to 5 and a hydroxide.

The surface on which the latent electrostatic image is formed may be on a rotating member, e.g. in the form of a cylinder. The surface on which the latent electrostatic image is formed may form part of a photo imaging plate (PIP). The electrostatic composition described in procedures (A), (B) and (C) above may be passed between a stationary electrode and a rotating member, which may be a member having the surface having a latent electrostatic image thereon or a member in contact with the surface having a latent electrostatic image thereon. A voltage may be applied between the stationary electrode and the rotating member, such that the ink particles comprising the colorant adhere to the surface of the rotating member. This may involve subjecting the electrostatic ink composition to an electric field having a field gradient of 50-400V/μm, or more, optionally 600-900V/μm, or more.

An intermediate transfer member may be used to transfer the image formed on the surface to a print substrate. The intermediate transfer member may be a rotating flexible member, which is optionally heated, e.g. to a temperature of from 80 to 160° C., optionally from 90 to 130° C., optionally from 100 to 110° C.

The print substrate may be any suitable substrate. The substrate may be any suitable substrate capable of having an image printed thereon. The substrate may comprise a material selected from an organic or inorganic material. The material may comprise a natural polymeric material, e.g. cellulose. The material may comprise a synthetic polymeric material, e.g. a polymer formed from alkylene monomers, including, but not limited to, polyethylene and polypropylene, and co-polymers such as styrene-polybutadiene.

In an example, the substrate comprises a cellulosic paper. In an example, the cellulosic paper is coated with a polymeric material, e.g. a polymer formed from styrene-butadiene resin.

The printed substrate may be used to form a security document, for example, an identity document, such as a passport, driving license or identity card. In one example, the printed substrate may be used to form a ticket, bank note or other document comprising a security feature that is only visible under UV light.

The printed image may be one that is invisible under white light but visible under UV light. For example, the printed image (UV colorant) may be visible when irradiated with light in the wavelength in the range of 10 to below 400 nm, for example, 250 to 380 nm. In one example, the printed image is visible when irradiated with light having a wavelength of 340 to 360 nm, for instance, 350 nm. Once irradiated, the image (UV colorant) may emit light (luminesce) at a wavelength of 400 to 1400 nm, for example, 400 to 700 nm. In one example, the UV colorant absorbs light in the UV and emits light (luminesces) in the visible part of the electromagnetic spectrum. The emitted light may be red. In one example, the emitted light may have a wavelength of about 600 to 620 nm, for example, 615 nm.

The image formed on the printed substrate may be a barcode or any desired security feature.

### Method of Manufacture

As discussed above, the present disclosure also relates to a method of producing an electrostatic ink composition. The method comprises adding an additive selected from at least one of an acid having a pKa of 1 to 5 and a hydroxide to composition comprising a UV colorant comprising a rare earth diketonate and a thermoplastic resin.

The composition may comprise ink particles comprising the thermoplastic resin and the UV colorant. The additive may be added to the composition and, for example, ground to facilitate contact between the additive and the resin and/or colorant. In one example, a charge director and, if desired, a charge adjuvant may also be added. It may also be possible to include additional carrier to form the electrostatic ink composition.

### Example 1—Ink Preparation

Indigo UV red ink (paste concentrate containing 25 weight % solids) was blended with an additive that was either an acid having a pKa of 1 to 5 or lithium hydroxide in the amounts shown in Table 1. Prior to blending with the additive, the Indigo UV red ink (Ink #0) had the following general composition:

65-85% of a hydrocarbon oil
9-31.5% of a thermoplastic resin comprising a copolymer of acrylic or methacrylic acid (Mw>100,000)
1.5-14% of Tris(1-(2-thienyl)-4,4,4,trifluoro-1,3-butanedion ato)bis(triphenylphosphine oxide) Eu(III), [C₄H₄SC₃HO₂CF₃]₃Eu[OP(C₆H₅)₃]₂
0.075-1.75% of Al di, tristearate/palmitate (as charge adjuvant)
0.05-1% of surfactant(s) (as charge director)

The additives were hand-ground using a mortar and pestle and blended into the ink paste using an Ultraturrex high IKA shear mixer for 30 min at 2000 rpm. After mixing, the ink samples were shaken at 40° C. overnight and then diluted to 2 weight % with oil. To all inks, an additional charge director was added till the conductivity was set at 80 pS/cm.

TABLE 1
Ink formulations

| | | g of | | mole | mole |
|---|---|---|---|---|---|
| | | additive | | additve/ | additive/ |
| | | per 100 g | molar | mole | mole |
| Code | | of ink | mass of | of | acid in |
| name | Ink/additive | paste | additive | colorant | polymer |
| Ink # 0 | UV red as is | 0 | n/a | n/a | n/a |
| Ink #3 | glutaric acid | 1.9 | 132.12 | 6.1 | 0.9 |
| Ink #4 | Lithium hydroxide | 0.4 | 24 | 7.2 | 1.0 |
| Ink #5 | Adipic acid | 2.0 | 146.1 | 5.7 | 0.8 |
| Ink #6 | Phthalic acid | 2.9 | 166.14 | 7.5 | 1.1 |
| Ink #7 | Polyacrylic acid | 1.1 | 70.06 | 6.4 | 0.9 |
| | (M = 2000) | | | | |

### Example 2—Printing Method

All the inks were printed using HP Indigo 7000 press, using the following set of voltages: Developer Roller Voltage (DVR)=444 V, Electrode Voltage (Vele)=1170 V, Squeegee Roller Voltage (Vsq)=375 V, and Cleaner Roller Voltage (Vcl)=325 V. The media was an Endurance coated offset media. Solid coverage areas and barcodes were generated at one and two separations (i.e. inks applied twice to same area, 200% coverage).

### Example 3—Fluorescence Intensity

The intensity of fluorescence of solid patches was measured using an SPEX Fluorlog 1680 0.22 M Double Spectrophotometer. The intensity was calculated as the difference between the peak fluorescence (at 615 nm) and the background (at 601 nm). The excitation was at 350 nm.

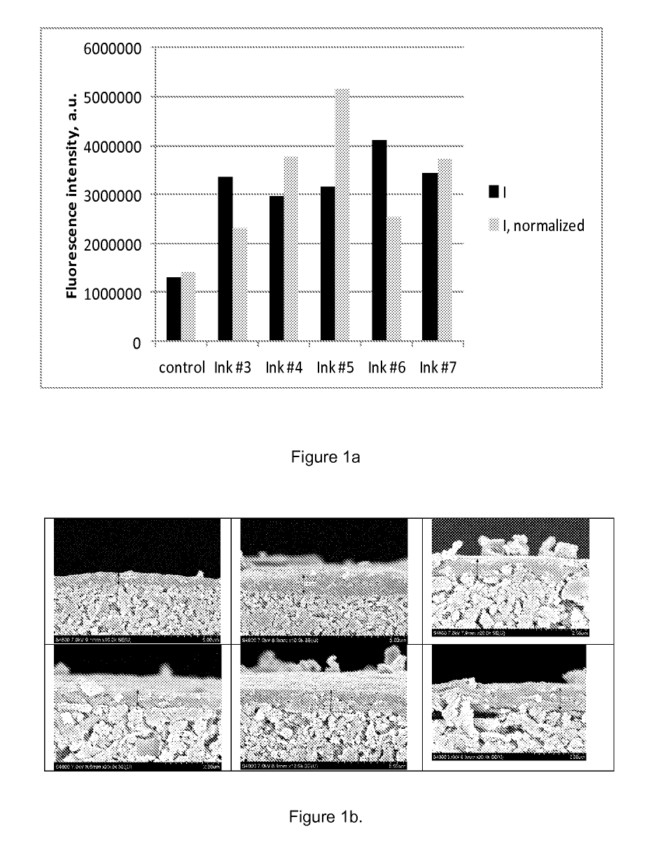

FIG. 1a shows the initial intensity (left hand bars) of fluorescence for the tested samples, generated at two separations. It can be seen that the inks containing the additive (Inks #3 to 7) have higher fluorescence intensities compared to the control ink (Ink #0).

The thickness of the ink films were measured (FIG. 1b, from left-right, top row: Ink #0, Ink #3, Ink #4; bottom row: Ink #5, Ink #6, Ink #7). It can be seen that the ink films were thicker for the inks containing the additive (Inks 3 to 7) compared to the control ink (Ink #0) from which additive was absent. FIG. 1a also shows the intensity of fluorescence normalized to the thickness of the ink film (right hand bars). Note that Inks #3 to #7 still have a larger fluorescence intensity than the control ink (Ink 0) after this normalization.

### Example 4. Thermal Stability of the Prints

For thermal stability studies, the printed samples were exposed in open in 50° C., 60° C., and 70° C., 50% RH (Relative Humidity) ovens, under continuous air flow, over the course of several days/weeks. The plots of the fluorescence intensity as the function of exposure time are shown below. Note that the experimental inks show a substantially improved stability to exposure to high temperatures; both the absolute intensity, and the rate of fluorescence decay are improved. Table 2 compares the half-decay times at 50° C.; the improvement as large as 10× is seen.

TABLE 2
Times of fluorescence half-decay at 50° C., hours

| | | | | | | |
|---|---|---|---|---|---|---|
| Ink | 0 (control) | 3 | 4 | 5 | 6 | 7 |
| T ½ | 16 | 24 | 64 | 76 | 116 | 70 |

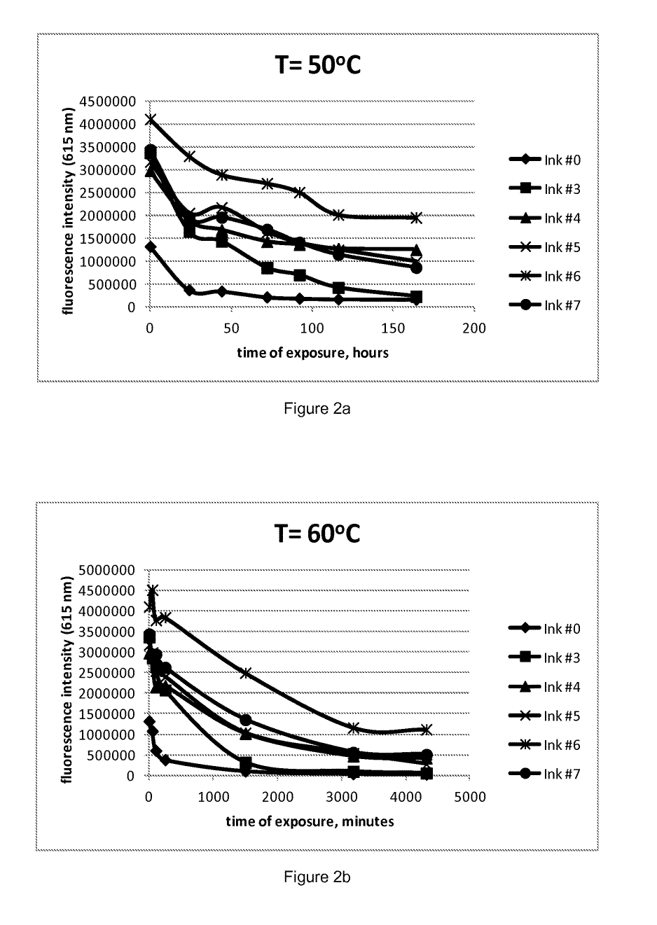

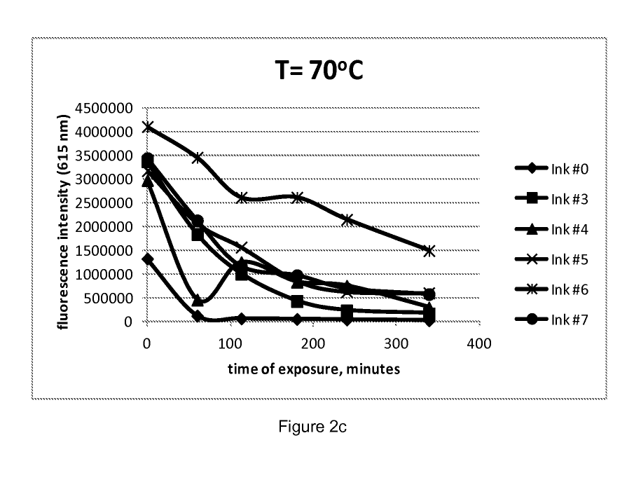

FIGS. 2a, 2b and 2c show kinetic plots of fluorescence degradation with the time of thermal fade of Inks #3-7, compared to control (Ink #0), at 50° C. (FIG. 2a), 60° C. (FIG. 2b) and 70° C. (FIG. 2c). It can be seen that, at each of these temperatures, the inks containing the additive (Inks #3 to 7) show improved stability to exposure to high temperatures compared to the control ink (Ink #0).

### Example 4 Barcode Readability

In order to check the stability of barcodes to thermal fade, the barcodes were printed in two separations on Edurance Coated offset media. The barcodes were read using a Honeywell 1900 Xenon 375UV Optic barcode reader, with a specially designed fixture. The time at which the barcode became unreadable was detected.

TABLE 3
Barcode readability after exposure at 50° C., 60° C. and 70° C.

| Ink | Ink #0 | Ink #3 | Ink #4 | Ink #5 | Ink #6 | Ink #7 |
|---|---|---|---|---|---|---|
| time to failure at | 1 | 3 | 19 | 23 | >25 | 7 |
| 50° C., days | | | | | | |
| time to failure at | 0.2 | 2 | 2 | 3 | >3 | 3 |
| 60° C., days | | | | | | |
| time to failure at | 0.01 | 0.11 | 0.19 | 0.23 | 0.35 | 0.23 |
| 70° C., days | | | | | | |

As based on the barcode readability at 50° C., 60° C. and 70° C., the predictions at 25° C. and 30° C., and 40° C. were made using Arrhenius analysis; the data are shown in Table 4.

TABLE 4
Predicted time of barcode readability, in years-to failure

| Ink | 25° C. | 30° C. | 40° C. |
|---|---|---|---|
| Control (Ink #0) | 1.9 | 0.5 | 0.03 |
| Ink #3 | 8.8 | 2.5 | 0.2 |
| Ink #4 | 4.7 | 1.5 | 0.2 |
| Ink #5 | 52.1 | 12.7 | 0.9 |
| Ink #6 | 32.4 | 9.0 | 0.8 |
| Ink #7 | 33.6 | 8.7 | 0.7 |

It can be seen that the control ink provides a good stability at 25° C. but at slightly elevated temperatures, the longevity of the prints are drastically reduced. The inks of this disclosure (Inks #3 to 7) extend the barcode readability by about 10×.

1. A system for electrostatic printing, said system comprising:
a UV colorant comprising a rare earth diketonate,
a thermoplastic resin, and
an additive selected from at least one of an acid having a pKa of 1 to 5 and a hydroxide.

2. A system as claimed in claim 1, which is an electrostatic ink composition comprising the UV colorant, thermoplastic resin and additive.

3. A system as claimed in claim 1, which is an ink set comprising
an electrostatic ink composition comprising the UV colorant and thermoplastic resin, and
a pre-treatment or post-treatment composition comprising the additive.

4. A system as claimed in claim 1, wherein the UV colorant is a lanthanide metal aromatic diketonate.

5. A system as claimed in claim 4, wherein the UV colorant is an europium metal complex having the formula:

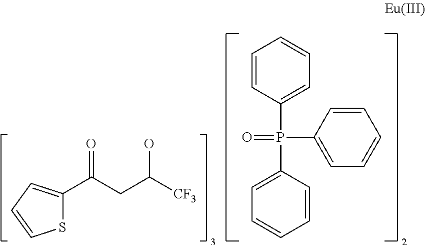

6. A system as claimed in claim 1, wherein the additive is an acid having a pKa of 1 to 5.

7. A system as claimed in claim 6, wherein the acid is a polyacid.

8. A system as claimed in claim 6, wherein the acid is selected from at least one of glutaric acid, adipic acid, phthalic acid and polyacrylic acid.

9. A system as claimed in claim 6, wherein the mole ratio of acid to UV colorant is in the range of 2-10 mol/mol.

10. A system as claimed in claim 1, wherein the additive is a lithium hydroxide and the system is an electrostatic ink composition comprising the UV colorant, thermoplastic resin and additive.

11. A system as claimed in claim 1, wherein the thermoplastic resin is a copolymer having acidic groups.

12. Use of a system as claimed in claim 1 in a method of printing a security feature on a print substrate.

13. A method of electrostatic printing, said method comprising:
(A) forming a latent electrostatic image on a surface; contacting an electrostatic ink composition comprising a UV colorant comprising a rare earth diketonate, a thermoplastic resin and an additive selected from at least one of an acid having a pKa of 1 to 5 and a hydroxide onto the latent electrostatic image to form an image on the surface, and transferring the image formed on the surface to a print substrate;
(B) forming a latent electrostatic image on a surface; contacting an electrostatic ink composition comprising a UV colorant comprising a rare earth diketonate and a thermoplastic resin onto the latent electrostatic image to form an image on the surface; pre-treating a print substrate with a pre-treatment composition comprising an additive selected from at least one of an acid having a pKa of 1 to 5 and a hydroxide; and transferring the image formed on the surface to the pre-treated print substrate; or
(C) forming a latent electrostatic image on a surface; contacting an electrostatic ink composition comprising a UV colorant comprising a rare earth diketonate and a thermoplastic resin onto the latent electrostatic image to form an image on the surface; transferring the image formed on the surface to a print substrate, and treating the printed print substrate with a post-treatment composition comprising an additive selected from at least one of an acid having a pKa of 1 to 5 and a hydroxide.

14. A printed substrate comprising a printed image that is invisible under white light but visible when irradiated with UV light, said substrate being obtainable by the method of claim 13.

15. A method of producing an electrostatic ink composition, said method comprising adding an additive selected from at least one of an acid having a pKa of 1 to 5 and a hydroxide to composition comprising a UV colorant comprising a rare earth diketonate and a thermoplastic resin.
